(19) United States
(12) Patent Application Publication
(10) Pub. No.: US 2022/0193944 A1
(43) Pub. Date: Jun. 23, 2022

(54) DEVICE FOR PROVIDING EDGE STRIPS, AND EDGING SYSTEM HAVING A DEVICE OF THIS TYPE

(71) Applicant: IMA Schelling Deutschland GmbH, Lübbecke (DE)

(72) Inventors: Lars CULEMANN, Stemwede (DE); Tim KOTTKAMP, Lübbecke (US); Simon KRÖKER, Espelkamp (DE); Hendrik GERDWILKER, Bad Essen (DE); Timo HEIDENREICH, Hüllhorst (DE); Stefan HÜSENER, Hille (DE); Rene PETKER, Espelkamp (DE); Björn STUKE, Lübbecke (DE)

(73) Assignee: IMA Schelling Deutschland GmbH, Lübbecke (DE)

(21) Appl. No.: 17/606,393

(22) PCT Filed: Aug. 18, 2020
(86) PCT No.: PCT/EP2020/073127

§ 371 Date: Oct. 25, 2021

(30) Foreign Application Priority Data
Aug. 21, 2019 (DE) 10 2019 122 413.6

(51) Int. Cl. B27D 5/00

(52) U.S. Cl. CPC B27D 5/003

(57) ABSTRACT

A device for providing edge strips, which device comprises a storing unit having individual storage places, which are designed to be at least indirectly loaded with edge strips, in particular edge strips that each form an edge roll at least in some parts. The storing unit is linearly movably arranged in or on a base frame.

### CROSS REFERENCE TO RELATED APPLICATIONS

This patent application is the US National Phase of and claims priority on and the benefit of International Application No. PCT/EP2020/073127 having an international filing date of 18 Aug. 2020, which claims priority on and the benefit of German Patent Application No. 10 2019 122 413.6 having a filing date of 21 Aug. 2019.

### BACKGROUND OF THE INVENTION

### Technical field

The invention relates to a device for providing edge strips comprising a storing unit with individual storage places which are designed for at least indirect loading with edge strips, in particular edge strips that each form an edge roll at least in some parts, and to an edging system having a device of this comprising an edging machine and at least one device comprising a storing unit with individual storage places which are designed for at least indirect loading with edge strips, in particular edge strips that each form an edge roll at least in some parts, wherein the at least one device is arranged in the region of the edging machine in such a way that at least one edge strip that can be arranged in the device can be fed directly from the storing unit of the device at least in some parts to the edging machine. Furthermore, the invention is directed to a use of the device or the edging system wherein the relevant edge strip is removed from a cassette which contains it at least partially and is accommodated in one of the storage places.

### Prior Art

Panels made from wood or wood substitute materials for the furniture industry usually have at least one at least partially coated top surface before they are processed. The types of these coatings range from paintwork to cladding with layers of real wood veneer or plastics. In addition to the particular optics, the surfaces coated in this way have an increased resistance to mechanical influences and liquids. The narrow edges of these panels are usually only coated afterwards, for instance after they have been cut to size. In the context of the so-called edging, a suitable edge strip is attached to the narrow sides of the panel at least in some parts. Its bond with the panel is usually based on adhesion or a micro-form fit by local melting.

In an industrial context, the edging of wood-based panels is carried out using an edging system in which the edge strips are attached by at least one edging machine in a continuous process. The edge strips are usually available in rolled-up form as edge rolls, so that even long lengths can be safely transported and stored in the most compact way possible. For the simplest possible handling, they can also be arranged within a cassette and, if necessary, can be unwound therefrom. Due to the variety of colors and decors as well as the thicknesses (depth) of the panels to be edged, the edge strips, which are then also different, often have to be exchanged for the appropriate variant.

A device for providing edge strips which comprises a tower-like storing unit is known from EP 1 346 805 A2. The storing unit has individual storage places which are designed for at least indirect loading with edge strips. The storage places are located one above the other with respect to a vertical.

In the specific embodiment, a storage place of the storing unit serves as a fixed place-changing position, which corresponds to a storage table arranged on the outside of the storing unit and located at the same height. From the storage table, a cassette loaded with an edge roll can be manually introduced into the place-changing position. This cassette is then sorted into another storage place within the storing unit by a handling apparatus arranged on the opposite side of the storing unit. Conversely, a cassette to be exchanged is first pulled out of its storage place within the storing unit by means of the handling apparatus and is transferred to the place-changing position, from where it is removed again manually and, for example, placed on the storage table for insertion of a new edge roll. An edging machine is supplied with edge strips via the handling apparatus of the device, which removes the required cassette from the storing unit and transfers it to the edging machine.

In particular, changing between different edge strips or the cassettes containing them is sometimes complex. The reason for this is the always necessary interposition of the handling apparatus, which is needed both for the distribution of the edge strips within the storing unit and for the supply of the edging machine with the edge strips that are required in each case. In addition to extensive maintenance, the movements of the handling apparatus to be coordinated require a correspondingly large amount of time and control effort.

### BRIEF SUMMARY OF THE INVENTION

The object of the present invention is therefore to further develop a generic device and an edging system equipped therewith so that the provision of edge strips can take place more economically overall.

In a device for providing edge strips this object is achieved according to the invention by a device for providing edge strips, comprising a storing unit with individual storage places which are designed for at least indirect loading with edge strips, in particular edge strips that each form an edge roll at least in some parts, characterized in that the storing unit is linearly movably arranged in or on a base frame. Furthermore, this object is achieved by an edging system, comprising an edging machine and at least one device as disclosed herein, wherein the at least one device is arranged in the region of the edging machine in such a way that at least one edge strip that can be arranged in the device can be fed directly from the storing unit of the device at least in some parts to the edging machine. Advantageous embodiments are the subject matter of the dependent claims and as disclosed herein.

It is proposed that the device should comprise a base frame, wherein the actual storing unit is now arranged linearly movably in or on this base frame. In other words, the device according to the invention can stand on a base above its base frame and/or can be fastened to another component, while the storing unit designed to accommodate edge strips is linearly movable relative to the base frame.

The advantage that is directly derived from this is that the design according to the invention does not require any rearrangement of edge strips or cassettes within the storing unit, since the edge strip required in each case, regardless of its arrangement in one of the storage places, can be moved into the required plane relative to an edging machine solely due to the linear mobility of the storing unit. In this way, it is possible to omit the handling apparatus required for the previously necessary distribution of edge strips within the storing unit. In addition, there is no longer any need to transfer the edge strip in question to an edging machine, since this strip can now be fed directly from the storing unit in that the storage place containing the required edge strip can be positioned beforehand, for example, opposite an edge feed of the edging machine.

According to a particularly preferred further development of the basic concept of the invention, at least one storage place of the storing unit can be designed in such a way that it can accommodate at least one edge strip. In other words, this storage place can be designed in such a way that a loose edge strip can be arranged or deposited therein, in particular if the edge strip is wound up to form an edge roll at least in some parts. As an alternative or in addition to this, at least one of the storage places can accommodate a cassette that contains the edge strip at least partially.

The storing unit has two opposing sides, and the design of its storage places can advantageously be adapted to the shape of the edge strips to be accommodated. Thus, at least one of the storage places can have at least one floor element extending at least partially between the sides of the storing unit. This can be designed, for example, in such a way that an edge strip can be placed directly on this floor element or at least partially supported on it. As an alternative or in addition to this, at least one of the storage places can have at least one support element arranged in the region of each side of the storing unit. The support elements can be designed, for example, in such a way that a cassette containing an edge strip can be placed on these support elements or can be at least partially supported on them.

In this connection, according to a preferred further development, the invention provides that the floor element and/or at least one support element of at least one storage place can be linearly movably mounted on the storing unit. By corresponding movement of the floor element and/or support element that can be displaced in this way, in particular the height of the associated storage place available to accommodate an edge strip or a cassette containing the edge strip can be adapted to the height required in each case. Specifically, an adaptation to edge strips having different widths or heights of their cassettes can thus be carried out. As a result, the storage place in question can be adapted with as little play as possible in relation to the edge strip to be accommodated. It is also conceivably possible in this way to adapt the number of storage places, which can be increased by one or even several places, for example by adapting them to correspondingly thin edge strips.

According to a particularly preferred further development of the invention, the storing unit or each storage place of the storing unit can be equipped with at least one reading module. In an advantageous manner, this can be a so-called contactless reading module, which can then receive transmitted data in a correspondingly wireless manner. In any case, the reading module is set up to communicate with at least one transmission module of an edge strip or a cassette containing the edge strip. For this purpose, for example, an RFID chip can be arranged in or on an edge strip or the cassette thereof, and the chip transmits the data stored in it to the reading module via a corresponding external stimulus. In this way, required information about the edge strip to be arranged in one of the storage places can be transmitted to the device and can then be used to control the storing unit. The information can contain, for example, information about the width and the decor or the color of the edge strip in question. In this way it is possible, for example, for the device and/or a controller that controls it to be more or less aware of the edge strips held in the storing unit and their respective storage places, in order to be able to provide the particular requested or required edge strip.

It is conceivable that the reading module itself or an additional component contains a transmission unit, which in turn can transmit information to the transmission module of the edge strip in question, which is then writable, for example. In this way, for example, information about the remaining length of the edge strip can be stored in its transmission module, so that those edge strips which have a remaining length required for the upcoming edging are always used.

In particular with a view to preferably automated control of the device, it is considered particularly advantageous if the device has a drive by means of which the storing unit can accordingly be moved automatically relative to the base frame. As an alternative or in addition to this, the storing unit can also be moved manually relative to the base frame of the device. For example, a device that is rather simple in its expansion stage may require the manual movement of its storing unit, while its higher expansion stage provides a correspondingly controlled drive. In principle, a device equipped with such a drive can also enable its storing unit to be moved manually in order to facilitate maintenance work and/or, for example, to ensure that the device can be used by manual handling even if the drive is defective.

The device according to the invention can have an interface which can be coupled to at least one further component or machine. In principle, the interface can enable a mechanical and/or data-transferring coupling. This enables, for example, simple integration into existing system structures and their operational processes, since signals available from the existing system or the controller thereof can be transmitted to the device via the interface and/or signals can be passed on from the device to the existing system or the controller thereof.

According to an advantageous embodiment of the invention, the device can have at least one drive unit via which an edge strip can be actively driven at least in some parts. This means that a free end of the edge strip can, for example, be movable from its arrangement within the storing unit and possibly also beyond it. In this way, the drive unit can at least transfer the edge strip from its storage place to an edging machine. The guiding of the edge strip into the edging machine can also take place entirely via the drive unit or can at least be supported thereby. In the specific embodiment, an active rotation of the wound edge strip and/or at least one friction wheel would be conceivable, for example, which has circumferential contact with the edge strip and drives or unwinds it by a rotation at least in some parts. In principle, the drive unit can interact with an edge strip that is at least partially arranged within a cassette or with an edge strip that is present without such a cassette.

The device can preferably have at least one brake unit by means of which an edge strip can be braked and/or fixed in relation to its mobility. Both the controlled drive and the uncontrolled movement behavior of the edge strip are regarded as the mobility of the edge strip, which can be attributed in particular to tensions within its material, which can result from the rolled-up state and/or temperature fluctuations. Of course, this also includes all other influences that cause movement of the edge strip, such as vibrations. The brake unit is designed in such a way that it at least brakes the movement of the same, for example by pulling on a portion of the edge strip. The brake unit can preferably fix the edge strip in such a way that control over its free end is always ensured. In this way, the independent retraction or movement of the free end of the edge strip can be countered, in that this is more or less held by the brake unit. The brake unit can in principle interact with an edge strip that is at least partially arranged within a cassette or with an edge strip that is present without such a cassette.

The invention provides that the device can have a cutting arrangement by means of which a portion of an edge strip can be severed if necessary. For example, only one edge strip portion, of which the length cut off by the cutting arrangement corresponds to the length to be processed, can be transferred to an edging machine. The cutting arrangement can in principle interact with an edge strip that is arranged at least partially within a cassette or with an edge strip that is present without such a cassette.

In the context of the invention, it is conceivable that the device extends either vertically or horizontally in its intended arrangement. Accordingly, the storing unit can be linearly movable parallel to a vertical or parallel to a horizontal relative to the base frame. Depending on the application, this results in advantageous options for using the available installation space.

Since the number of storage places of the vertically movable storing unit, which lie one above the other in relation to a vertical orientation, is already limited naturally by the particular ceiling height, this can be increased accordingly by a horizontal orientation of the storing unit. In particular, the height of the edge feed on an edging machine limits the maximum possible height of the storing unit for the direct unwinding of an edge strip from its storage place, since the uppermost storage place must be in the plane of the edge feed for this purpose. As a result, the maximum number of possible storage places results from the space available below this plane. Any recesses in the base naturally allow greater heights for the storing unit, since in its maximally lowered position it could then be moved at least partially into such a recess.

The advantage of a vertical orientation of the device lies in the fact that the edge strips held in it can generally enter an edging machine without rotating about the longitudinal axis. The decisive factor here is its orientation in relation to its cross section, which orientation is parallel to the wood-based panels that are usually processed horizontally. In contrast, a horizontal orientation of the device requires a 90° rotation of an edge strip about its longitudinal axis in order for this edge strip, which is then lying within the storing unit in relation to its cross section, to be aligned parallel to the narrow edges of a wood-based panel. In particular, the rotation of an edge strip about its longitudinal direction can stress its structure. On the other hand, the horizontal orientation of the device allows a greater length of its storing unit, so that it accordingly provides more storage places for edge strips. The more advantageous orientation of the device is to be selected by the competent specialist in each individual case on the basis of the aforementioned criteria.

According to a preferred further development, the device can comprise at least one manipulator. This manipulator can be, for example, a multi-axis robot arm and/or a storage and retrieval machine (SRM). The manipulator is arranged and set up in such a way that it reaches every storage place of the storing unit. In this way, the manipulator can be used to load the storage places with edge strips and to empty them by removing the edge strips from the storage places as required. Of course, this is independent of whether the respective edge strips are present as such or are arranged at least partially within a cassette. Compared to manual loading and removal of the edge strips, the manipulator enables more extensive automation of the device.

In connection with the at least one manipulator, it is provided that the device according to the invention can also have a storage arrangement. The storage arrangement is used for the local provision of edge strips or cassettes containing edge strips. With the help of the manipulator, these can then be removed individually or at least in pairs from the storage arrangement and transferred to the storage facility of the device. In this way, the storage places of the storing unit can be individually equipped with edge strips from the storage arrangement. Conversely, the storage arrangement is used for the local provision of edge strips or cassettes containing edge strips, which can be removed from the storage device individually or at least in pairs by the manipulator in order then to be transferred to the storage arrangement.

By the combination of a storage arrangement and a manipulator, the number of locally available edge strips can be correspondingly increased, which enables shorter reaction times and/or a greater selection of edge strips that are different from one another.

According to a further expansion stage of the device according to the invention, based on the presence of a manipulator, a transfer device can also be provided, by means of which further edge strips held in a nearby machine store can be accessed. Edge strips located in the machine store can be removed individually or at least in pairs by the transfer device and transferred to the manipulator, which can then be transferred to the storage arrangement and/or the storing unit. Conversely, edge strips located in the storage arrangement and/or the storing unit can be removed individually or at least in pairs by the manipulator and passed on to the transfer device, from where they can be transferred back to the machine store.

The device according to the invention which has now been presented enables an overall extremely economical provision of edge strips. In particular, the linear movability of the storing unit which can be loaded with edge strips makes the crucial contribution to placing an edge strip into one of the free storage places in a more or less disordered manner. If necessary, this can be brought into the required plane relative to an edging machine by simply moving the entire storing unit in order to be able to access the edge strip located therein. A previous, in particular mechanical, sorting of the edge strips is therefore no longer necessary. This is based on the knowledge of data about the edge strips held in the storing unit, which data result from the communication which is possible in at least one direction between the device and the edge strip in question or the cassette containing the edge strip. The currently required edge strip can always be positioned in the plane of the edge feed of the edging machine by means of a corresponding controller in order to enter the edging machine. With further expansion stages, such as at least one manipulator and a storage arrangement for edge strips, the efficiency of the device can be increased further by increasing its reserve capacity.

Furthermore, the invention relates to an edging system which comprises an edging machine and at least one device described above. The device is arranged in the region of the edging machine in such a way that at least one edge strip that can be arranged in the device can be fed at least partially to the edging machine. The at least partial feeding of an edge strip takes place directly from the storing unit of the device. The advantages resulting from this have already been explained in more detail in connection with the device according to the invention, so that in order to avoid repetitions, reference is made at this point to the previous explanations.

According to a preferred further development of the edging system, the storage places of the device, which can be at least indirectly loaded with an edge strip, can be arranged relative to the base frame in the plane of an edge feed of the edging machine by linear movement of the storing unit. In other words, the edge strip required in each case is brought into the plane of the edge feed of the edging machine by linear movement of the entire storing unit in order to run directly from the storing unit into the edge feed.

The manipulator can advantageously have at least one vertical axis of rotation. As an alternative or in addition to this, the manipulator can have at least one vertical lifting axis. The manipulator can be rotated accordingly via the vertical axis of rotation. The manipulator is able to move an edge strip or a cassette containing the edge strip between different heights via the vertical lifting axis. For example, the removal can take place from a first plane, while the delivery takes place in a second plane that differs from the first plane.

The invention provides that at least two storage arrangements can be arranged in the region of the manipulator. In particular, via the vertical axis of rotation of the manipulator, it is always possible to align the manipulator in such a way that an edge strip or a cassette containing the edge strip can be removed from one of the storage arrangements or transferred thereto.

The use of the device according to the invention and/or the edging system according to the invention is of course not only limited to the edging of wood-based panels. The edges of panels made of any material can be edged, such as those of solid wood panels. In the context of the invention, the mention of an edge strip always means its presence without or with a cassette containing it, regardless of whether this is explicitly mentioned or not.

Ultimately the present invention relates to a use of the device according to the invention or the edging system according to the invention. When the device or the edging system containing this device is used, it is provided that the particular edge strip that can be provided by this means is in principle removed from a cassette which contains it at least partially. In other words, for this purpose the storing unit of the device is loaded with at least one cassette containing an edge strip roll, from which the edge strip located therein is removed as required. Said cassette is accommodated by one of the storage places of the storing unit of the device. Compared to the handling of open edge strips rolled up to form edge strip rolls, the arrangement thereof in a cassette offers easier handling overall.

### BRIEF DESCRIPTION OF THE DRAWINGS

The invention will be explained in more detail in the following with reference to FIGS. 1 to 7.

In the drawings:

FIG. 1 shows a device according to the invention in a perspective representation;

FIG. 2 shows the device from FIG. 1 in its arrangement in front of an edging machine in a top view;

FIG. 3 shows the device from FIG. 1, in an extended expansion stage, in an otherwise unchanged representation;

FIG. 4 shows the expansion stage from FIG. 3, in an expansion stage extended by comparison thereto, in an otherwise unchanged representation;

FIG. 5 shows the expansion stage from FIG. 4 in an expansion stage, again extended by comparison, in an otherwise unchanged representation;

FIG. 6 shows two side-by-side arrangements from FIG. 4 as a further expansion stage in an otherwise unchanged representation;

FIG. 7 shows two side-by-side arrangements from FIG. 5 as a further expansion stage in an otherwise unchanged representation;

FIG. 8 shows the device according to the invention from FIG. 1 in a first alternative embodiment in an otherwise identical representation rotated by 90°; and

FIG. 9 shows the device according to the invention from FIG. 1 in a second alternative embodiment in an otherwise identical representation.

### DETAILED DESCRIPTION OF PREFERRED EMBODIMENTS

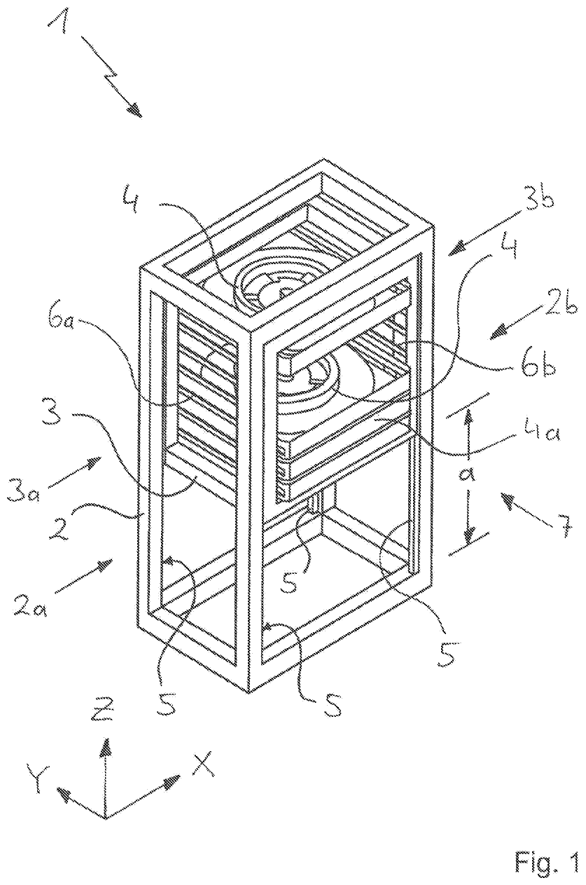

FIG. 1 shows a device 1 according to the invention in a perspective representation. The device 1 comprises a base frame 2, which in the present case has frame structures with rectangular tubes connected to one another essentially at right angles. The design shown here is exemplary and only represents one possible embodiment for the base frame 2. A storing unit 3 which serves to accommodate edge strips 4 is arranged between two sides 2a, 2b of the base frame 2, which have frame structures spaced apart from one another. In the present case, the construction of the storing unit 3 is the same as that of the base frame 2, since it also has a frame structure with rectangular tubes connected to one another essentially at right angles.

Due to the correspondingly smaller design of the storing unit 3 compared to the base frame 2, the storing unit 3 in the embodiment shown here by way of example is located within the internal dimensions of the base frame 2, wherein the storing unit 3 is linearly movably guided with its opposite sides 3a, 3b on the sides 2a, 2b of the base frame 2. In contrast, the length of the storing unit 3 extending parallel to its sides 3a, 3b is shorter than the base frame 2, so that it is movable within the base frame 2 with a corresponding stroke length a relative to the base frame. For this purpose, rails 5 are arranged in a suitable manner on the base frame 2. As can be seen by way of example in FIG. 1, one of these rails 5 can be arranged on one of the opposing inner surfaces of the frame structures extending between the two sides 2a, 2b of the base frame 2, so that each of the sides 2a, 2b has two such rails 5. Regions of the storing unit 3 that correspond to these rails 5 (and are not shown in greater detail here) ultimately facilitate its linear mobility with respect to the base frame 2. The linear movement of the storing unit 3 is preferably carried out by a drive which cannot be seen here; however, it can of course take place manually as an alternative or in addition to this.

Looking at the storing unit 3, it becomes clear that it has a large number of support elements 6a, 6b arranged on its two sides 3a, 3b. In the present case, the support elements 6a, 6b are designed like rails, which each extend perpendicular to the length of the storing unit 3 on the two sides 2a, 2b of the base frame 2. The support elements 6a, 6b can be seen here on the inner surfaces of the rectangular tubes of the frame structures located on each side 3a, 3b of the storing unit 3. The support elements 6a, 6b can be mounted on the sides 3a, 3b of the storing unit 3 so as to be linearly movable in relation to their lateral spacing from one another, in a manner that is not shown in detail.

The support elements 6a, 6b subdivide the interior of the storing unit 3 into individual storage places 7, wherein two support elements 6a, 6b lying opposite one another in relation to the two sides 3a, 3b of the storing unit 3 define a storage place 7. The storage places 7 defined in this way serve to accommodate the edge strips 4, which in the present case are each arranged at least partially rolled up to form an edge roll within a cassette 4a. The cassettes 4a have side surfaces which correspond to the support elements 6a, 6b and enable them to be pushed into and pulled out of the storing unit 3 accordingly. Alternatively, and not shown in more detail, the individual storage places 7 can also be defined by floor elements which then extend at least partially between the sides 3a, 3b of the storing unit 3.

The floor elements can be connected to the storing unit 3 in a fixed or movable manner, so that they enable it to be pulled out of the storing unit 3 in the manner of a drawer. In contrast to the loading of the storing unit 3 with cassettes 4a containing edge strips 4, the floor elements enable edge strips 4 to be accommodated directly, for example by placing them on the floor elements. Of course, the floor elements can also be combined with the support elements 6a, 6b which accommodate the cassettes 4a. It is also conceivable that the support elements 6a, 6b serve to support floor elements, so that in this way edge strips 4 can also be arranged directly in the storing unit 3. Furthermore, what has been said above with regard to the support elements 6a, 6b can also apply to these floor elements, with regard to the possible change in spacing from one another by a movable connection to the storing unit 3.

The device 1 or the storing unit 3 can have a drive unit, not shown in detail, via which at least parts of an edge strip 4 can be actively driven if required. The drive unit can interact either directly with the relevant edge strip 4 or with a cassette 4a containing the edge strip 4. Furthermore, the device 1 or the storing unit 3 can have a brake unit, likewise not shown in detail, by means of which an edge strip 4 can be braked and/or fixed with respect to its mobility. The brake unit can interact either directly with the relevant edge strip 4 or with a cassette 4a containing the edge strip 4. The device 1 or the storing unit 3 can also have a cutting arrangement, also not shown in detail, by means of which a portion of an edge strip 4 can be cut off. The cutting arrangement can interact either directly with the relevant edge strip 4 or with a cassette 4a containing the edge strip 4. Depending on the design, the drive unit or brake unit or cutting arrangement can also be at least part of a cassette 4, which can be controlled via a corresponding control of the device 1 or of the storing unit 3. A division into two would also be conceivable in that the cassettes 4a comprise the corresponding mechanical parts of the drive unit or brake unit or cutting arrangement, while the device 1 or the storing unit 3 have the corresponding drive for this, which can then be coupled to them.

In principle, the device 1 can be aligned in such a way that its storing unit 3—as can be seen in FIG. 1—is linearly movable parallel to a vertical Z relative to the base frame 2. In contrast, the device 1 can of course also be used in an orientation rotated by 90°, so that its storing unit 3 is linearly movable parallel to a horizontal X relative to the base frame 2.

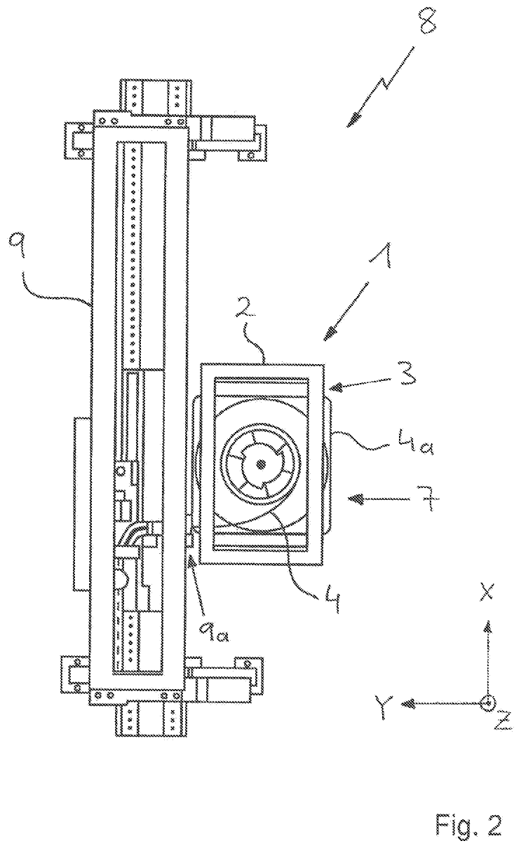

FIG. 2 shows the top view of an edging system 8, which comprises an edging machine 9 and the device 1 explained in more detail above. It can be seen that the device 1 is located directly in front of the edging machine 9 in relation to a spacing direction Y running at right angles to the horizontal X and to the vertical Z. As a result, the device 1 is arranged in the region of the edging machine 8 in such a way that one of the edge strips 4 arranged in the device 1 is guided directly from the storing unit 3 of the device 1 into the edging machine 9. The position of the device 1 is chosen so that the edge strip 4 runs directly into an edge feed 9a of the edging machine 9, through which it is used in a manner not shown for edging panels, in particular wood-based panels. Previously, the storage place 7 of the device 1 loaded with the desired edge strip 4 was arranged in the plane of the edge feed 9a, in that its storing unit 3 was moved linearly by a movement running parallel to the vertical Z in the present case.

Due to the almost direct entry of an edge strip 4 into the edge feed 9a of the edging machine 9, the otherwise exposed portion of an edge strip 4 between the device 1 and the edging machine 9 is reduced to a minimum, which leads to significantly reduced stresses within the course of the edge strip 4. In addition, the direct feeding of the edge strip 4 into the edging machine 9 eliminates any threading effort and the adjustment work required here.

Depending on the requirements, the edging system 8 can be designed in such a way that the device 1 can be moved relative to the edging machine 9, which, with regard to the representation of FIG. 2, means the displacement in and counter to directions parallel to the horizontal X and/or to the spacing direction Y. For example, the device can be movable relative to the device 1 in a direction running parallel counter to the spacing direction Y, in order to be able to carry out any maintenance work. Here, for example, free access to the edge feed 9a is made possible. Of course, this displaceability can also be used to move the device 1, for example, if necessary, between two edging machines 9 spaced parallel with respect to one another, in order to be able to provide the edge strip 4 required in each case on one or the other edging machine 9.

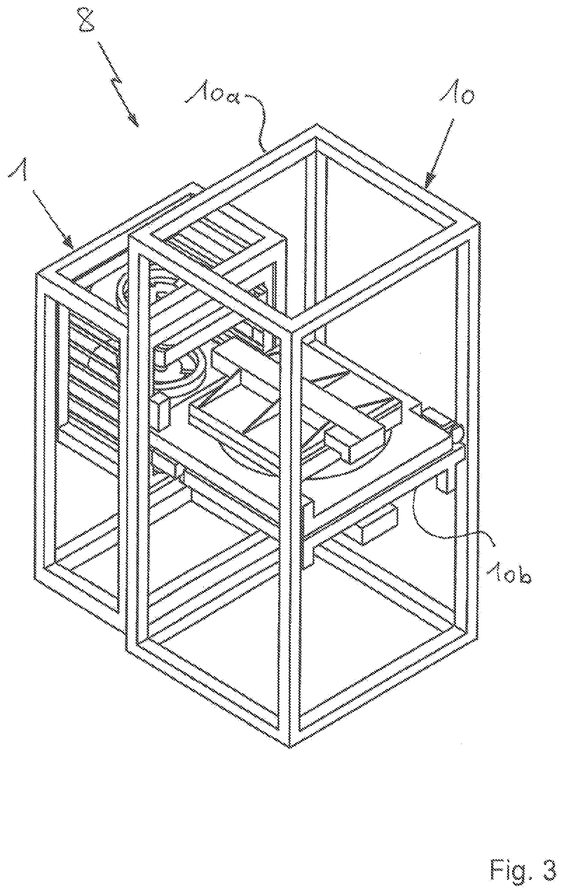

FIGS. 3 to 7 each show extended expansion stages of the device 1, by means of which the performance of the device can be increased with regard to the provision of edge strips 4.

FIG. 3 shows a first extended expansion stage in which the device 1 is combined with a manipulator 10. In the present case, an embodiment of the manipulator 10 as a storage and retrieval machine (SRM) is shown, which is linearly movable parallel to the lifting direction of the device 1. Specifically, for this purpose the manipulator 10 has a lifting unit 10b linearly movably mounted in a frame 10a, which can accommodate at least one edge strip 4 or a cassette 4a loaded with an edge strip 4. The manipulator 10 serves to load the device 1 with edge strips 4 or with cassettes 4a each containing an edge strip 4 and to empty the device 1. In this expansion stage, the manipulator 10 can be loaded manually. The manipulator 10 can be moved synchronously with the device 1 by means of a corresponding coupling. This coupling can take place mechanically and/or by means of control technology. A corresponding control of the manipulator 10 enables the device 1 to be loaded and unloaded even during operation.

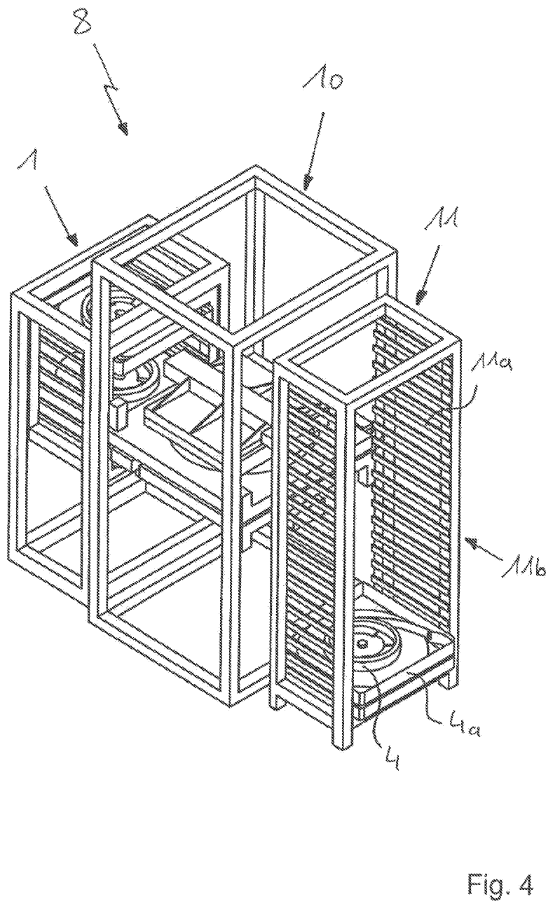

FIG. 4 shows a further expansion stage of the device 1 which, compared to the expansion stage from FIG. 3, is now additionally combined with a storage arrangement 11. In the present case, the storage arrangement 11 is designed like a shelf system with—as already explained above with regard to the device 1—lateral support elements 11a in the form of rails that have a plurality of slots 11b arranged one above the other for edge strips 4 or for cassettes 4a each containing one edge strip 4. With the help of the manipulator 10, edge strips 4 that can be stored in the storage arrangement 11 can now be removed therefrom individually or at least in pairs and can be transferred to the device 1, wherein the storage places 7 of their storing unit 3 are loaded appropriately. For this purpose, the linearly movable lifting unit 10b of the manipulator 10 is moved into the required plane of the storage arrangement 11, where it removes an edge strip 4 or the cassette 4a containing the edge strip 4 from the related slot 11b. Then, if necessary, the lifting unit 10b of the manipulator 10 moves into another plane in order to transfer the edge strip 4 or the cassette 4a to a free storage place 7 of the storing unit 3 of the device 1. Of course, this can also be done the other way round, in order to feed edge strips 4 or cassettes 4a out of the device 1 to the storage arrangement 11.

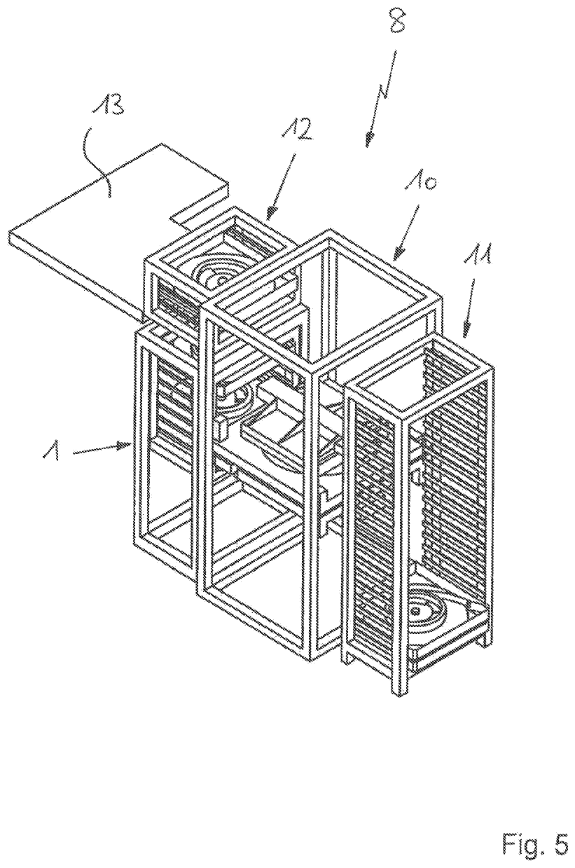

FIG. 5 illustrates the structure of a further expansion stage which additionally includes a transfer device 12. It can be seen that in the present case the transfer device 12 is arranged on the device 1, where it corresponds to a machine store 13. The machine store 13 is located above or directly on the edging machine 9 in a manner not shown in greater detail. In this arrangement, the storage arrangement 11 serves as a buffer for edge strips 4 or cassettes 4a, while the transfer device 12 feeds and removes new edge strips 4 or cassettes 4a, preferably fully automatically. In other words, edge strips 4 or cassettes 4a, which can be stored in the machine store 13 provided here by way of example near the machine, can be transferred to the manipulator 10 individually or at least in pairs. In contrast, edge strips 4 or cassettes 4a arranged in the storing unit 3 and/or the storage arrangement 11 can be transferred individually or at least in pairs to the transfer device 12 by the manipulator 10.

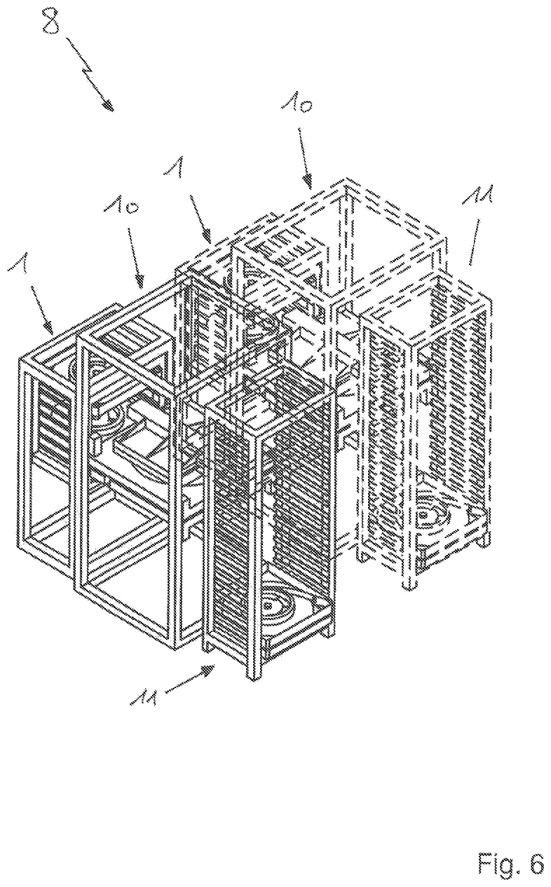

FIG. 6 shows an expansion stage which comprises a duplication of the structure already shown in FIG. 4. Specifically, two devices 1 are provided here, each of which is combined with its own manipulator 10 and a storage arrangement 11 located on the relevant manipulator 10. As a result of this structure, the two devices 1 can work alternately, so that correspondingly high cycle rates can be achieved. For this embodiment, the edging machine 9 has two edge feeds 9a, not shown here, in order to be able to process the edge strips 4 of the relevant device 1.

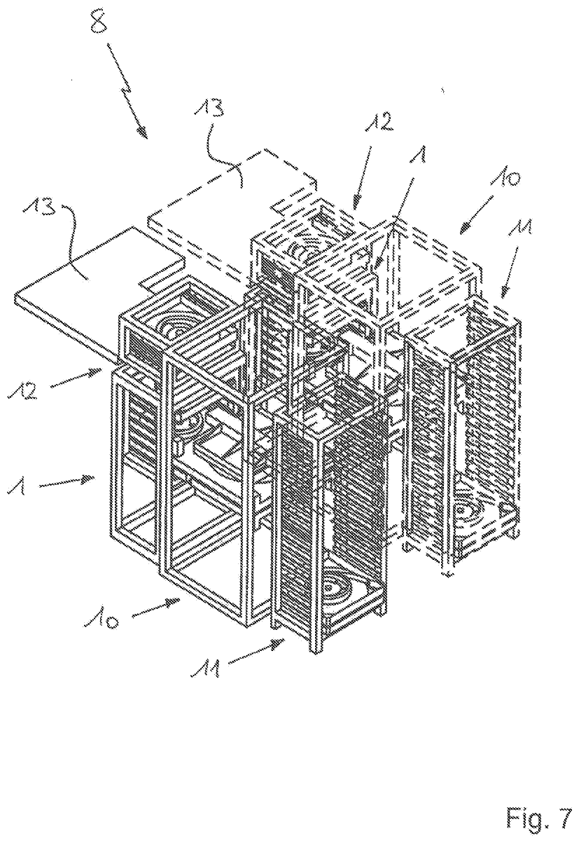

FIG. 7 shows a last possible expansion stage which comprises a duplication of the structure already shown in FIG. 5. Specifically, two devices 1 are also provided, each of which is combined with its own manipulator 10 and a storage arrangement 11 located on the relevant manipulator 10, as well as a transfer device 12 and a machine store 13, in particular near the machine. Here, too, the two devices 1 can work alternately in order to achieve a high cycle rate for edging panels.

In principle, the device 1 of all expansion stages can be equipped with at least one reading module (not shown in detail). Specifically, the reading module can be arranged in the region of the storing unit 3. It is also conceivable that each storage place 7 of the storing unit 3 is equipped with such a reading module. The aim is the automated transmission of information about the respective edge strips 4 or cassettes 4a, which are currently in the storing unit 3 or which are removed from it or are just being fed in. Thus, the edge strips 4 or cassettes 4a can be equipped with a corresponding transmission module on which the required information is stored. Such a transmission module can preferably contain at least one RFID chip or can be designed as such a chip. The reading module or the reading modules are set up to communicate with the transmission modules. This can take place in one direction or in both directions, which means the mere reading out of data or a combination of reading out and writing of data by the reading module on a transmission module.

In an advantageous manner, the device 1 according to the invention can comprise at least one interface (not shown in greater detail here). This interface is then designed to be coupled to at least one further component or machine, in particular mechanically and/or in a data-transferring manner. In this way, all components or machines of an edging system 8 can be controlled via a corresponding controller.

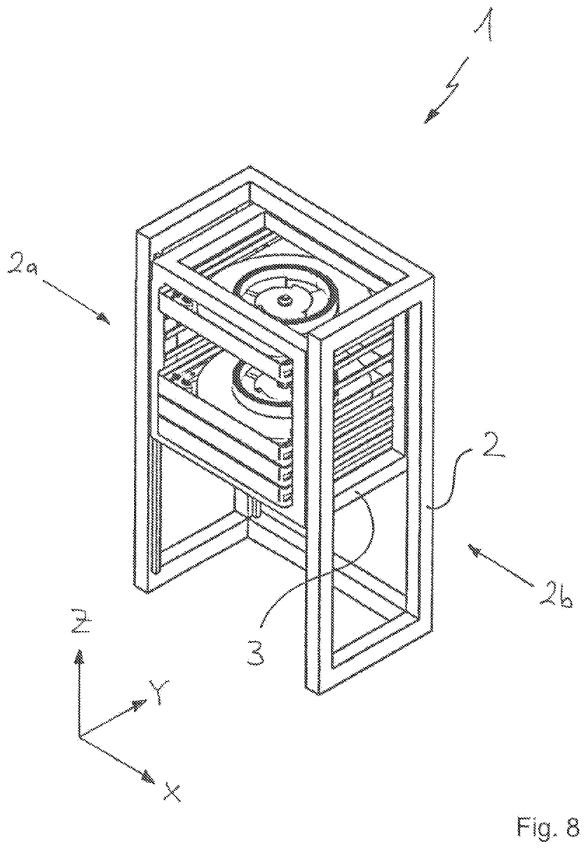

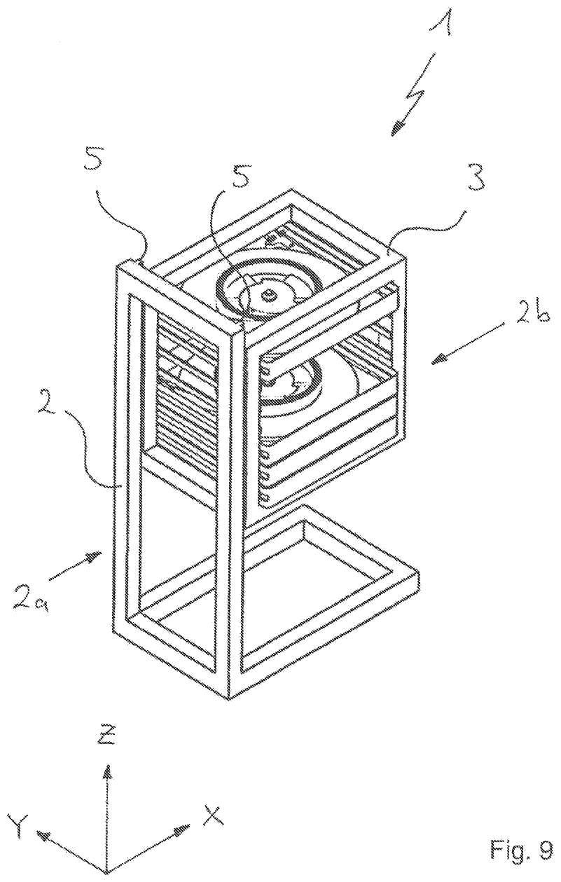

The device 1 shown in FIG. 1, and also shown only by way of example in the other FIGS. 3 to 7, is shown in FIGS. 8 and 9 in alternative embodiments, in each case in a perspective representation. To avoid repetitions and for better clarity, only some of the reference signs can be recognized here, since identical parts correspond to the parts already shown in FIGS. 1 to 7. The essential difference between the variants shown in FIGS. 8 and 9 lies in the different shape of the base frame 2 carrying the storing unit 3.

It can be seen from FIG. 8 that in this variant of an embodiment the frame structures each located on one of the two sides 2a, 2b of the base frame 2 are connected to one another via two rectangular tubes extending between them and parallel to the horizontal X. In contrast, the base frame 2 shown in FIGS. 1 and 3 to 7 has a total of four of its two frame structures, each located on one side 2a, 2b and connecting rectangular tubes which extend there between the opposite corners of said frame structures and parallel to the horizontal X. In the variant shown in FIG. 8, the rectangular tubes connecting the frame structures lie one above the other in relation to the vertical Z, so that the base frame 2 is essentially U-shaped in a top view, which is not shown in detail here.

FIG. 9 shows a variant of an embodiment, in which the view of the base frame 2 may be designated as L-shaped. It can be seen that the base frame 2 has a frame structure located on only one side 2a, while the opposite side 2b is more or less frameless. As already shown in FIGS. 1 to 7, the lower region of the base frame 2, which is composed of rectangular tubes, is designed to be closed. Specifically, the two rectangular tubes running parallel to the horizontal X each extend away from a lower corner of the frame structure located on the side 2a, and they are connected to one another at the end via a rectangular tube running parallel to the spacing direction Y. With the inclusion of the frame structure located on the side 2a, a closed, essentially rectangular shape is produced.

Further variants, not shown in detail here, for the base frame 2 are also conceivable, for example in the form of a central lifting column below the storing unit 3.

Of course, the profiles referred to as rectangular tubes in the context of the description can also—unlike in FIGS. 1 to 9—have a different cross-sectional shape, such as a U, C or L shape. A design as a round tube is also conceivable here. Combinations of the above are also possible, as well as variants thereof within a base frame 2.

### REFERENCE SIGNS

1 device
2 base frame of 1
2a side of 2
2b side of 2
3 storing unit of 1
3a side of 3
3b side of 3
4 edge strip
4a cassette, in particular containing 4
4 rail on 2
6a support element on 3
6b support element on 3
7 storage place of 3
8 edging system
9 edging machine of 8
9a edge feed of 9
10 manipulator of 8
10a frame of 10
10b lifting unit of 10
11 storage arrangement of 8
11a support element of 11
11b slot of 11
12 transfer device of 8
13 machine store of 8
a stroke length of 3 in 2
X horizontal
Y spacing direction
Z vertical

1. A device (1) for providing edge strips (4), comprising a storing unit (3) with individual storage places (7) which are designed for at least indirect loading with edge strips (4), in particular edge strips that each form an edge roll at least in some parts,
wherein
the storing unit (3) is linearly movably arranged in or on a base frame (2).

2. The device (1) according to claim 1,
wherein
at least one of the storage places (7) is designed to accommodate at least one edge strip (4) and/or at least one cassette (4a) that contains the edge strip at least partially.

3. The device (1) according to claim 1,
wherein
the storing unit (3) has two opposite sides (3a, 3b), wherein at least one of the storage places (7) has at least one floor element extending at least partially between these sides (3a, 3b) and/or at least one support element (6a, 6b) arranged in the region of each side (3a, 3b).

4. The device (1) according to claim 3,
wherein
the floor element and/or the support elements (6a, 6b) of at least one storage place (7) is/are linearly movably mounted on the storing unit (3).

5. The device (1) according to claim 1,
wherein
that the storing unit (3) or each storage place (7) of the storing unit (3) is equipped with at least one reading module, which is set up to communicate with a transmission module, in particular an RFID chip, of an edge strip (4) or of a cassette (4a) containing an edge strip (4).

6. The device (1) according to claim 1, wherein
the storing unit (3) can be moved relative to the base frame (2) by an, in particular automated, drive and/or manually.

7. The device (1) according to claim 1,
further comprising
at least one interface which can be coupled to at least one further component or machine, in particular mechanically and/or in a data-transferring manner.

8. The device (1) according to claim 1,
further comprising
a drive unit via which an edge strip (4), which in particular is at least partially arranged within a cassette (4a) can be actively driven at least in some parts.

9. The device (1) according to claim 1,
further comprising
a brake unit via which an edge strip (4), in particular at least partially arranged within a cassette (4a), can be braked and/or fixed in relation to its mobility.

10. The device (1) according to claim 1,
further comprising
a cutting arrangement by which a portion of an edge strip (4), in particular unwound from an edge roll, can be cut off.

11. The device (1) according to claim 1,
wherein
the storing unit (3) is linearly movable parallel to a vertical (Z) or parallel to a horizontal (X) relative to the base frame (2).

12. The device (1) according to claim 1,
further comprising
a manipulator (10), by means of which each storage place (7) can be loaded with an edge strip, (4) or a cassette (4a) at least partially containing the edge strip (4), and can be emptied.

13. The device (1) according to claim 12,
further comprising
a storage arrangement (11) from which edge strips (4) which can be stored therein can be removed individually or at least in pairs by the manipulator (10) and can be transferred to the storage places (7) for loading the storing unit (3), wherein edge strips (4) which can be arranged in the storing unit (3) can be removed therefrom individually or at least in pairs by the manipulator (10) and can be transferred to the storage arrangement (11).

14. The device (1) according to claim 13,
further comprising
a transfer device (12) by which edge strips (4) that can be stored in a machine store (13) can be transferred individually or at least in pairs to the manipulator (10), wherein edge strips (4) that can be arranged in the storing unit (3) and/or the storage arrangement (11) can be transferred individually or at least in pairs by the manipulator (10) to the transfer device (12).

15. An edging system (8), comprising an edging machine (9) and at least one device (1) according to claim 1, wherein the at least one device (1) is arranged in the region of the edging machine (8) in such a way that at least one edge strip (4) that can be arranged in the device (1) can be fed directly from the storing unit (3) of the device (1) at least in some parts to the edging machine (9).

16. The edging system (8) according to claim 15,
wherein
the storage places (7) of the device (1), which can each be at least indirectly loaded with an edge strip (4), can be arranged relative to the base frame (2) in the plane of an edge feed (9a) of the edging machine (9) by linear movement of the storing unit (3).

17. The edging system (8) according to claim 12,
wherein
that the manipulator (10) has at least one vertical axis of rotation and/or at least one vertical lifting axis.

18. The edging system (8) according to claim 17,
wherein
at least two storage arrangements (11) are arranged in the region of the manipulator (10).

19. A method for providing edge strips (4), wherein a relevant edge strip (4) is removed from a cassette (4a) which contains it at least partially and is accommodated in a storage place (7).
